(19) United States
(12) Patent Application Publication
(10) Pub. No.: US 2006/0010369 A1
(43) Pub. Date: Jan. 12, 2006

(54) Enhancements of data types in XML schema

(76) Inventors: Stephan Naundorf, Heidelberg (DE); Uwe Schlarb, Oestringen (DE); Gerhard Wenzel, Wieslock (DE)

Correspondence Address: FISH & RICHARDSON, P.C., PO BOX 1022, MINNEAPOLIS, MN, 55440-1022, US

(21) Appl. No.: 10/886,150

(22) Filed: Jul. 7, 2004

(51) Int. Cl. G06F 17/24

(52) U.S. Cl. 715/513

(57) ABSTRACT

In an embodiment, an XML data type may be extended with enhancements without creating a new data type. Enhancements to a “base” data type may be made in parallel such that multiple enhanced data types reference the same base data type. The enhanced XML data types can co-exist in XML schema with the base data types and each other without being redundant or conflicting with each other.

### BACKGROUND

Extensible Markup Language (XML) can facilitate the creation and sharing of information formats and data, as well as organizing data and documents. A markup language can refer to a kind of text encoding that represents text as well as details about the structure and appearance of the text. XML is “extensible” because the markup symbols in the markup language can be unlimited and self-defining. XML can have a self-documenting format to describe structure and field names, as well as specific values. For example, XML can describe the content of a document in terms of what data is being described. XML can also allow a user to add tags and structure to their documents and data, as well as facilitating the exchange of structured text and information.

The XML tags can represent “metadata”. The metadata is information that characterizes the data in a document or file. Scripts or other programs may make use of these tags and assign meaning to them. For instance, if a document is assigned one or more XML tags, then a program can use the tags and a representation language to relate the document to the name of its creator and other documents with the same creator. A tag for the date of creation of the document also could be used to relate the document to other documents with the same creation date. A script or program also can define and relate XML tags in a taxonomic relationship where the metadata represent parent-child or sibling relationships. An XML schema may be created to have a standard syntax for tags and/or extensions between companies.

Companies differ in their approaches to forming their XML document structures. The approaches can differ according to the differing business scenarios, and the XML structure may differ on a case-by-case basis. The companies may define a particularized XML standard based on their business needs and/or based on their industry. As a result, the XML schema for a document exchanged between companies may have an XML syntax that is inconsistent, redundant, and/or incompatible between the companies trying to conduct business.

### SUMMARY

In one implementation, the present disclosure relates to a method for generating an enhanced XML data type. The method includes defining a namespace associated with a base XML data type, defining one or more elements corresponding to the base XML data type, and defining one or more attributes corresponding to the base XML data type. The method also includes defining a namespace associated with the enhanced XML data type and defining at least one enhanced element and/or enhanced attribute that corresponds to the enhanced XML data type.

In one aspect, the method may include defining a software component version for the base XML data type and defining a software component version for the enhanced XML data type. The method may also involve generating an instance of the enhanced XML data type that includes data for elements corresponding to the base XML data type and data for attributes corresponding to the base XML data type. The instance generation may include data for at least one of the enhanced elements and attributes. The method may involve qualifying the data corresponding to at least one of the enhanced elements and attributes with the namespace associated with the enhanced XML data type.

In another aspect, the method may involve generating a parallel enhanced XML data type by defining the namespace associated with a base XML data type and defining elements and attributes corresponding to the base XML data type. The method involves defining a namespace associated with the parallel enhanced XML data type and defining at least one enhanced element and/or enhanced attribute that corresponds to the parallel enhanced XML data type.

In another implementation, an enhanced XML data type includes a base XML data type namespace, one or more base elements and attributes, an enhanced XML data type namespace, and at least one enhanced element and/or enhanced attribute that corresponds to the enhanced XML data type namespace. The enhanced XML data type may include a base software version identifier, as well as an enhanced software version identifier that is associated with the enhanced XML data type namespace. The enhanced XML data type may be compatible with a base XML data type and a parallel enhanced XML data type that corresponds to the base XML data type. The enhanced XML data type and the parallel enhanced XML data type can be independently defined with respect to each other, and the data type enhancements may be performed by different parties.

In another implementation, an article is described that includes a machine-readable medium with machine-executable instructions that are operable to cause one or more machines to generate an enhanced XML data type. The instructions define a namespace associated with a base XML data type, define one or more elements corresponding to the base XML data type, and define one or more attributes corresponding to base XML data type. The instructions also define a namespace that is associated with the enhanced XML data type and define at least one enhanced element and/or enhanced attribute corresponding to the enhanced XML data type.

The systems and techniques described here may provide one or more of the following advantages. Businesses may also define enhanced XML data types based on existing XML data types. Each enhancement can be defined independently. The enhancements may be based on an industry sector or a particular business process, and can be dynamically interrelated between businesses based on original XML schema standards. Businesses can define parallel enhancements to XML data in parallel, in which multiple enhanced XML data types can reference an existing XML data type. The multiple enhanced XML data types may co-exist in an XML schema without being redundant and without interfering or conflicting with each other. Also, multiple enhanced XML data types can be defined without modifying the existing XML data type upon which they are based.

In another benefit, the current disclosure can permit a business to reduce an amount of redundant data. The reduction of redundant data can free space in memory and storage systems. Businesses can more easily exchange data and XML documents without having to spend their time and resources in determining the meanings and relationships of the XML documents.

The details of one or more implementations are set forth in the accompanying drawings and the description below. Other features and advantages will be apparent from the description and drawings, and from the claims.

### DRAWING DESCRIPTIONS

FIG. 1 shows an example of an enhanced XML definition.

FIG. 2 illustrates enhanced XML code.

FIG. 3 illustrates a navigation tree for the XML example of FIG. 1.

FIG. 4 illustrates XML schema syntax for the example of FIG. 1.

FIG. 5 shows an example of parallel enhanced XML.

Like reference symbols in the various drawings may indicate like elements.

### DETAILED DESCRIPTION

The present disclosure describes methods and systems for extending XML structures and data types in XML schema. In one implementation, enhancements for XML data types and structures are defined in parallel. The enhancements are based on an existing XML data type and can be defined independently of each other. For example, multiple businesses can each define their own set of enhancements to XML data types and structures in an XML schema. Each business may enhance an existing data type by defining a set of new fields that enhances an existing data type to form a complex data type. Because enhancements can be defined independently, parallel enhancements can be defined with respect to XML data types and structures in an XML schema. In XML schema syntax, the sets of new fields can be described as groups or attribute groups. Each attribute group may include non-XML-schema-based information about the data type the attribute group enhances. The complex set of data types, which includes the new fields, can be dynamically determined based on the original, existing data type definition and the independent enhancements.

In conventional systems, a new data type is created when a data type is extended. One or more users may have to keep track of multiple data types that may be variations of a common data type. The multiple data types can result in redundant data, which may be confusing to different users of the data types.

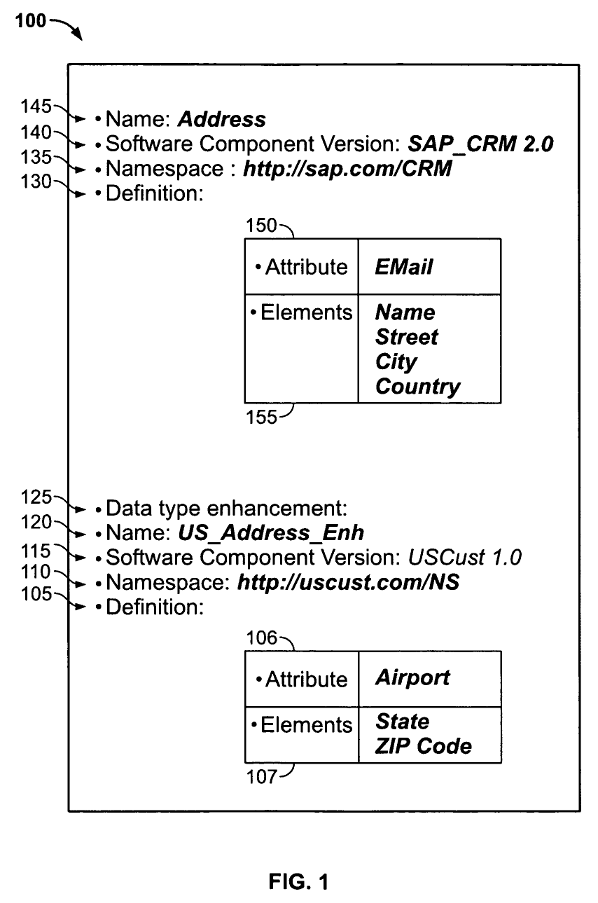

In an embodiment, modification of the original data type is not required when enhancements are made because data types and structures can be enhanced in parallel. The original data type may have multiple enhanced definitions without having to be altered. The enhanced data types described herein do not form new data types, but rather are extensions of the existing, original data type. In other words, the original data type forms a “base” data type for which one or more extensions may be defined and referenced. As shown in FIG. 1, the enhanced data type 100 has information that includes (1) the “base” data type and (2) the group attributes or set of attributes of the enhancement. The enhanced data types may be transported and exchanged among various system components for one or more businesses. The data type enhancements may be defined with respect to a software component and/or version.

For the scenario in FIG. 1, a customer may want to add an attribute “Airport” 106 and elements “State” and “ZIPCode” 107 to data type “Address” 145 of a software component version “SAP_CRM 2.0” 140. For example, the customer may be interested in knowing the closest airport for the data type Address 145 for a business. The software component version “SAP_CRM 2.0” 140 is identified at a namespace “http://sap.com/CRM” 135 that has an existing definition 130, including an attribute “Email” 150 and the elements of Name, Street, City, and Country 155. Because an XML instance may contain element or attribute names from more than one XML vocabulary, each XML vocabulary can be given a namespace to avoid naming collisions and ambiguity between identically named elements or attributes.

The data type enhancement 125 has a data type of “US_Address_Enh” 120 for a software component version “USCust 1.0” 115 in a namespace “http://uscust.com/NS” 110, which differ from the namespace 135 and software component version 140 of the original data type 145.

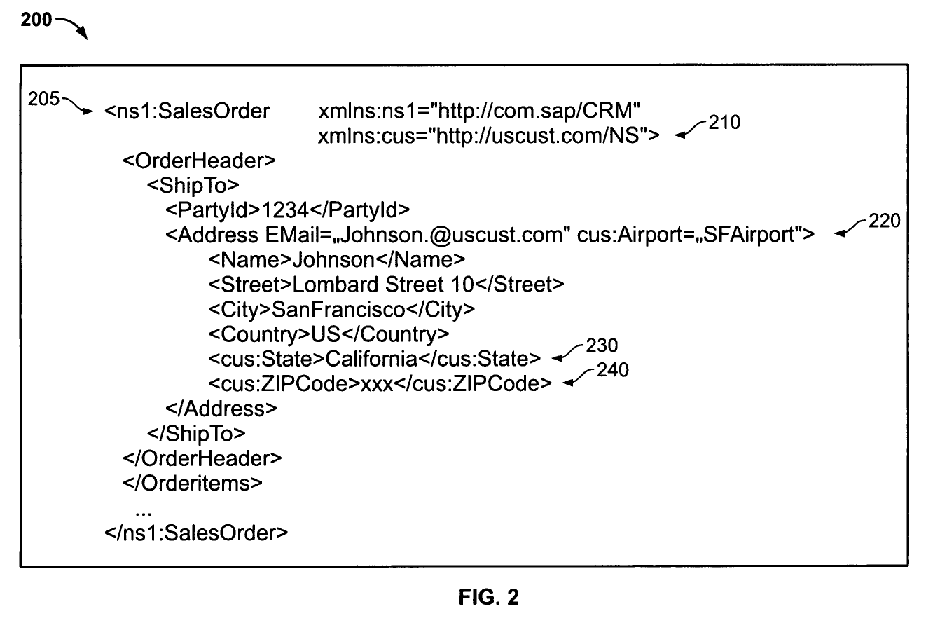

FIG. 2 illustrates an example of an enhanced data type in an XML instance 200 of the enhanced data type shown in FIG. 1. An object editor can show the XML instance and allow the XML instance 200 to be edited by a user in a graphical user interface. The object editor for the XML instance 200 can show a data type, a namespace, and enhancements, such as an enhanced namespace, an enhanced attribute, and an enhanced element. In this implementation, an XML document includes text, usually a particular encoding of Unicode such as UTF-8 or UTF-16, although other encodings may be used. In particular, FIG. 2 shows an XML instance of a SalesOrder 205. The enhanced data type 125 of FIG. 1 is an additional, enhanced attribute of the Address 145 data type in the XML instance of FIG. 2. The Airport 220 attribute of the enhanced data type 125 is shown, along with the elements of State 230 and ZIPCode 240. In order to avoid problems with attributes and elements having the same name as the original data types or each other, the enhanced data types have namespaces 210 that are defined with respect to the customer or the party modifying the XML instance 200.

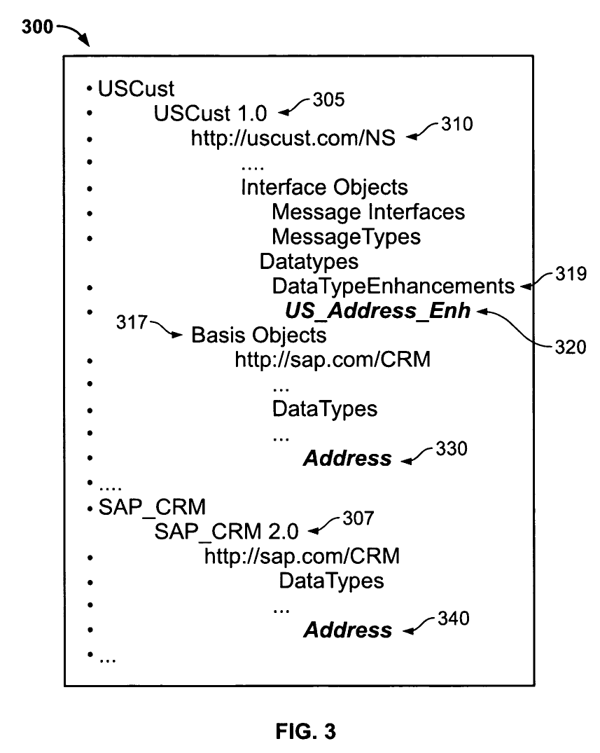

FIG. 3 shows an example of a navigation tree using the data type enhancement 125 of FIG. 1. The navigation tree can show a representation of the data types and the enhancements as organized in a repository. The data type enhancements can be defined in their own software component and namespace. The software component of the enhanced data type can be used as an underlying “basis” component so that the objects of the basis component are visible to the component that is based on it. For example, in FIG. 3, the software component version USCust 1.0 (305) is based on the software component version SAP_CRM 2.0 (307). The data type 340 and the data type enhancement 320 are shown in a navigation tree 300. The data type 340 and the data type enhancement 320 may be in an integration repository for one or more business systems.

In one implementation, a customer may define and maintain their own software component version 305, namespace 310, and data type enhancement 320. The customer may only be able to view and not edit the original data type 330, which is shown under the node Basis Objects 317. The field under DataTypeEnhancements 319, US_Address_Enh 320, references the original data type 330. The original data type 330 may only be edited under the original software component 307.

As shown in the navigation tree 300, the XML schema of the Address data type 330 of the USCust 1.0 software component version 305 in the node Basis Objects 317 differs from the XML schema of the original Address data type 340 of the SAP_CRM 2.0 software component version 307. The XML schema of the Address 330 of the USCust software component version 305, in contrast to data type Address 340, references to a group and/or attribute group with the attribute Airport 106 and the elements State and ZipCode 107 of the enhancement (shown in FIG. 1).

Data type enhancements may be provided by a program or script that permits at least two additional input fields to existing data type: “enhanced data type”, and “XML Namespace”. The “enhanced data type” field can allow a field to be referenced to an existing data type. The “XML Namespace” field refers to the namespace by which the data type enhancement belongs in the navigation tree 300. Alternatively, the “XML Namespace” may also be defined in a namespace other than what is indicated in the navigation tree 300 when two or more different software components are attempting to exchange data containing content of the same additional fields.

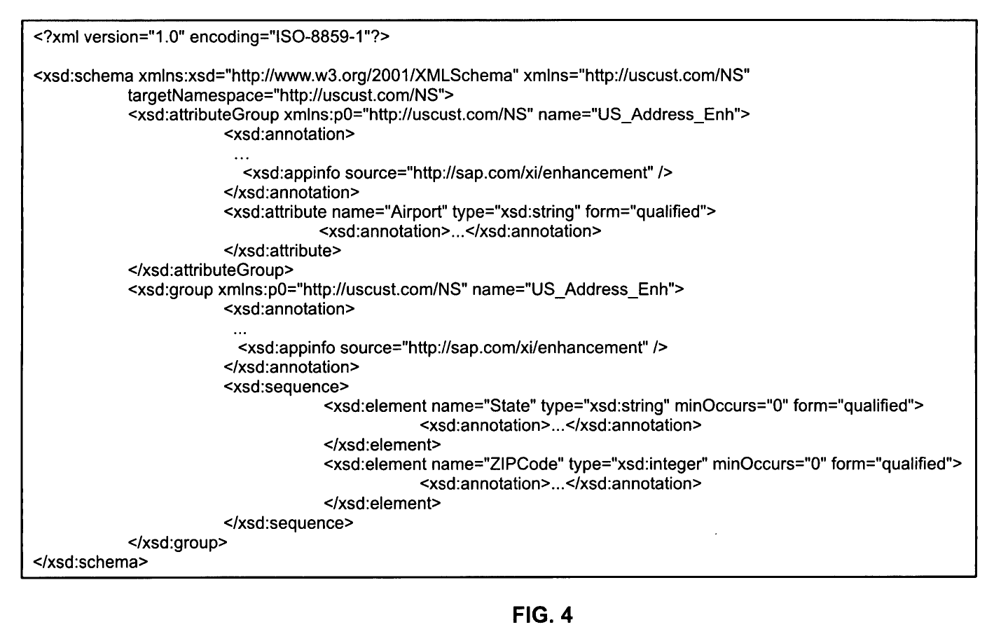

FIG. 4 shows an exemplary XML schema definition of the enhanced data type of US_Address_Enh 120 of FIG. 1. The sets of additional attributes and elements of the enhancement are described in XML schema syntax as attributes and groups.

XML data types can be enhanced with new elements and attributes to make the new elements and attributes available in proxies to use in program code. In this respect, data types can be enhanced without requiring the original data type to be modified. The enhancement of data types is stable in the sense that upgrading of the original data types can be done without requiring manual adaptations, and the new data types can automatically mix with one or more enhancements. The enhancements may be made from customers and other related businesses.

Parallel enhancements may also be supported. In one case, a data type may be enhanced by multiple parties, and the enhancements may be independent of one another for the same data type. In one implementation, a data type may be associated with a certain industry sector, and multiple parties may enhance that data type based on their function or relationship in that industry sector. For example, a business may have an address data type 145, but the data type may be enhanced by a party interested in sending a package to a particular individual (e.g., a title or role of the individual, such as president), or a party interested in sending a package to a particular business group (e.g., an internal mail code). The data type can be enhanced by a party interested in sending a package for the general use of the business (e.g., a receiving department address for office supplies). In this aspect, parallel enhancements may also be added for particular business needs.

Because the parallel enhancements of the XML data types are defined independently of other enhanced data types, the existing XML data types can be enhanced without defining new data types. A conventional XML schema standard extension concept may result in defining a new data type. For the conventional XML schema standard extension, if the data type is referenced in a message type, a new data type may require the message type to be modified. However, if a new data type is not used, as in the case of using parallel enhancements of an existing data type, the message types may not have to be modified.

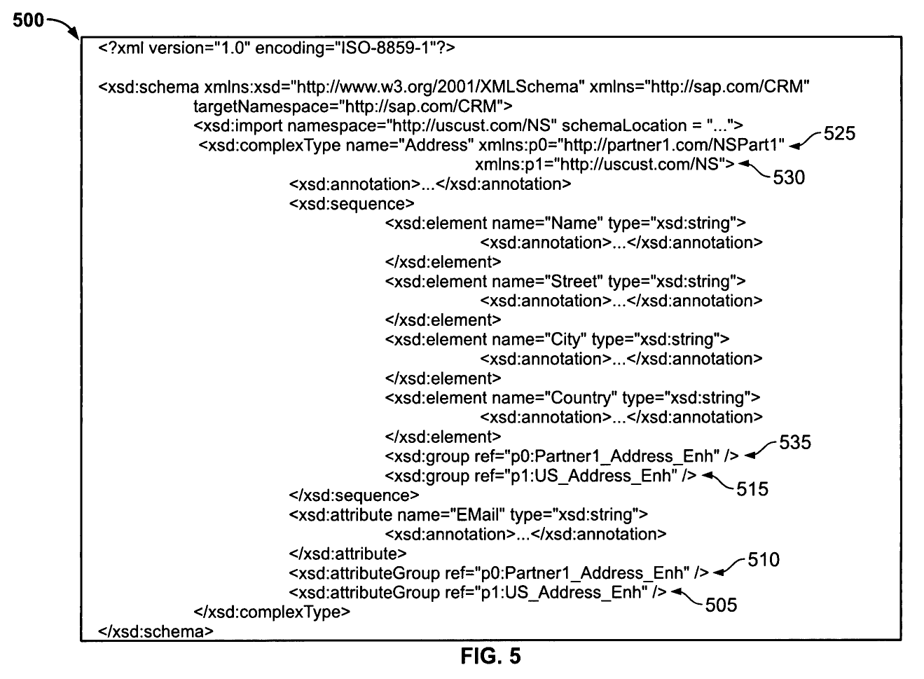

FIG. 5 shows a data type example with parallel mixing of enhancements of a data type. In the parallel mixing of enhancements, a data type, such as Address 145 in FIG. 1, can be referenced by two or more enhanced data types. The two or more enhanced data types may or may not be from the same customer, and may include the groups and the attribute groups of several enhanced definitions.

In FIG. 5, an example using the Address 145 data type from FIG. 1 with two enhanced data types in an XML schema definition 500 is shown. The data type 145 can be independently enhanced by one or more parties (e.g., an enhanced data type for a partner company, an enhanced data type for a customer, an enhanced data type for a contractor, and the like). The XML schema definition 500 of FIG. 5 has references to the data type enhancement 125 of FIG. 1 (e.g., the name, US_Address_Enh 120, 505, 515, and the namespace, http://uscust.com/NS 110, 530). The XML schema definition 500 also has additional references to a second enhancement. In this example, the second enhancement is an independent enhancement to the data type 145 that is defined by a partner company. For the second enhancement, a partner company, Partner1, can extend the Address data type 145 by the partner company's attribute, p1:Partner1_Address_Enh 510, and element, p0:Partner1_Address_Enh, 535. The partner company's namespace, http://partner1.com/NSPart1 525, is listed in the XML schema definition 500 in parallel with the customer's namespace, http://uscust.com/NS 110, 530.

In one implementation, ABAP (Advanced Business Application Programming) proxies can be used for enhancements. For example, ABAP proxy generation can be extended by generating ABAP dictionary append structures for the data type enhancements. ABAP is a programming language developed by SAP of Walldorf, Germany. ABAP proxies may be generated for the message interfaces that use the data types defined in a repository. The proxy generation can generate ABAP Objects classes (e.g., for outbound message interfaces), ABAP Objects interfaces (e.g., for inbound message interfaces), ABAP Objects exception classes (e.g., for fault message types), ABAP Dictionary data element (e.g., for data types), and ABAP Dictionary structures (e.g., for message types and data types). ABAP Objects can use a single inheritance model and provide support for object features such as encapsulation, polymorphism, and persistence.

One or more techniques can be used to extend ABAP Dictionary structures, such as an include-technique and an append-technique. The data type enhancement described herein may be generated using the technique of ABAP Dictionary appended structures. An appended structure can refer to a structure that can be extended, in which the structure can support several independent appends in parallel. Appended structures can be designed when enhancing ABAP Dictionary structures with additional fields. So, ABAP proxy generation can be extended by generating ABAP Dictionary-append structures for the data type enhancements.

In a navigation tree of the ABAP proxy generation, the data type enhancements can be represented as a separate node. Proxy generation can be started for the separate node (i.e., data type enhancement node) and can create a corresponding append structure to be appended to the proxy structure of the enhanced data type. To avoid naming conflicts, prefixes can be used for the append structure name and related fields. For customer-specific namespaces, for example, prefixes with a “Z” or a “/ . . . /-namespace” format can be used to avoid naming conflicts.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although only a few implementations have been described in detail above, other modifications are possible. Nevertheless, it will be understood that various modifications may be made without departing from the spirit and scope of the claims below. Accordingly, other implementations are within the scope of the following claims.

What is claimed is:

1. A method for generating an enhanced XML data type, the method comprising:
defining a namespace associated with a base XML data type;
defining one or more elements corresponding to the base XML data type;
defining one or more attributes corresponding to base XML data type;
defining a namespace associated with the enhanced XML data type; and
defining at least one of an enhanced element and an enhanced attribute corresponding to the enhanced XML data type.

2. The method of claim 1, further comprising:
defining a software component version corresponding to the base XML data type; and
defining a software component version corresponding to the enhanced XML data type.

3. The method of claim 1, further comprising:
generating an instance of the enhanced XML data type including:
data corresponding to the one or more elements corresponding to the base XML data type;
data corresponding to the one or more attributes corresponding to the base XML data type;
data corresponding to at least one of the enhanced element and the enhanced attribute; and
qualifying the data corresponding to at least one of the enhanced element and the enhanced attribute with the namespace associated with the enhanced XML data type.

4. The method of claim 3, further comprising generating a parallel enhanced XML data type by:
defining the namespace associated with a base XML data type;
defining the one or more elements corresponding to the base XML data type;
defining the one or more attributes corresponding to base XML data type;
defining a namespace associated with the parallel enhanced XML data type; and
defining at least one of an enhanced element and an enhanced attribute corresponding to the parallel enhanced XML data type.

5. An enhanced XML data type comprising:
a base XML data type namespace;
one or more base elements;
one or more base attributes;
an enhanced XML data type namespace; and
at least one of an enhanced element and an enhanced attribute corresponding to said enhanced XML data type namespace.

6. The enhanced XML data type of claim 5, further comprising:
a base software version identifier; and
an enhanced software version identifier associated with the enhanced XML data type namespace.

7. The enhanced XML data type of claim 5, wherein the enhanced XML data type is compatible with a base XML data type.

8. The enhanced XML data type of claim 7, wherein the enhanced XML data type is compatible with a parallel enhanced XML data type corresponding to the base XML data type.

9. The enhanced XML data type of claim 8, wherein the enhanced XML data type and the parallel enhanced XML data type are independently defined with respect to each other.

10. The enhanced XML data type of claim 9, wherein the enhanced XML data type and the parallel enhanced XML data type are adapted to be defined by different parties.

11. The enhanced XML data type of claim 9, wherein the parallel enhanced XML data type is compatible with a base XML data type.

12. The enhanced XML data type of claim 9, wherein the base XML data type, the enhanced XML data type, and the parallel enhanced XML data type comprise unique namespaces to avoid naming conflicts.

13. The enhanced XML data type of claim 12, the parallel enhanced XML data type comprising:
a parallel base software version identifier; and
a parallel software version identifier associated with the parallel enhanced XML data type namespace.

14. The enhanced XML data type of claim 8, wherein the enhanced XML data type and the parallel enhanced XML data type comprise ABAP (Advanced Business Application Programming) dictionary appended structures.

15. The enhanced XML data type of claim 8, wherein the base XML data type is configured to serve as a reference XML data type for the enhanced XML data type and the parallel enhanced XML data type.

16. An article comprising a machine-readable medium including machine-executable instructions operable to cause one or more machines to:
define a namespace associated with a base XML data type;
define one or more elements corresponding to the base XML data type;
define one or more attributes corresponding to base XML data type;
define a namespace associated with the enhanced XML data type; and
define at least one of an enhanced element and an enhanced attribute corresponding to the enhanced XML data type.

17. The article of claim 16, further comprising instructions operative to cause the one or more machines to:
define a software component version corresponding to the base XML data type; and
define a software component version corresponding to the enhanced XML data type.

18. The article of claim 16, further comprising instructions operative to cause the one or more machines to:
generate an instance of the enhanced XML data type including:
data corresponding to the one or more elements corresponding to the base XML data type;
data corresponding to the one or more attributes corresponding to the base XML data type;
data corresponding to at least one of the enhanced element and the enhanced attribute; and
qualify the data corresponding to at least one of the enhanced element and the enhanced attribute with the namespace associated with the enhanced XML data type.

19. The article of claim 18, further comprising instructions to cause the one or more machines to generate a parallel enhanced XML data type, said instructions operative to cause the one or more machines to:
define the namespace associated with a base XML data type;
define the one or more elements corresponding to the base XML data type;
define the one or more attributes corresponding to base XML data type;
define a namespace associated with the parallel enhanced XML data type; and
define at least one of an enhanced element and an enhanced attribute corresponding to the parallel enhanced XML data type.

20. The article of claim 19, wherein the enhanced elements and attributes corresponding to the enhanced XML data type and the parallel enhanced XML data type are independently defined.
